(19) United States
(12) Patent Application Publication
(10) Pub. No.: US 2025/0119977 A1
(43) Pub. Date: Apr. 10, 2025

(54) METHOD FOR CENTRALIZED INTERNET PROTOCOL (IP) ADDRESS ALLOCATION OF USER EQUIPMENT (UE) CONTROL PLANE

(71) Applicant: Nokia Technologies Oy, Espoo (FI)

(72) Inventors: Ákos LEITER, Budapest (HU); Péter FAZEKAS, Budapest (HU)

(21) Appl. No.: 18/907,936

(22) Filed: Oct. 7, 2024

(30) Foreign Application Priority Data
Oct. 9, 2023 (GB) 2315432.1

(51) Int. Cl. H04W 76/27

(52) U.S. Cl. CPC H04W 76/27

(57) ABSTRACT

A method includes receiving, by a user equipment (UE), a first message from an apparatus, the first message including a first identifier of the UE and a second identifier that identifies an address of a first component in a network. The UE transmits a second message to the apparatus, the second message including a request for an address of a second component of the network. The UE receives a third message from the network apparatus, the third message including a third identifier of the address of the second component of the network, and the UE transmits a fourth message to the second component of the network, the fourth message including the identifier of the address of the second component of the network.

### FIELD

Various example embodiments relate generally to wireless networks and, more particularly, to centralized internet protocol (IP) address allocation of the user equipment (UE) control plane.

### BACKGROUND

In fifth generation (5G) wireless systems, the signaling protocol between a user equipment (UE) and a core network (e.g., the NAS-non-access stratum protocol) is carried over radio resource control (RRC) signaling on the radio interface, and N2 interface (e.g., next-generation application protocol (NGAP) over stream control transmission protocol (SCTP)) between base station and access and mobility management function (AMF). For NAS targeting other network functions (e.g., session management function (SMF) for session management, policy control function (PCF) for policy management), messages are transparently relayed by the AMF over the service based core interfaces.

### SUMMARY

In an aspect of the present disclosure, a method includes receiving, by a user equipment (UE), a first message from an apparatus, the first message including a first identifier of the UE and a second identifier that identifies an address of a first component in a network. The UE transmits a second message to the apparatus, the second message including a request for an address of a second component of the network. The UE receives a third message from the network apparatus, the third message including a third identifier of the address of the second component of the network, and the UE transmits a fourth message to the second component of the network, the fourth message including the identifier of the address of the second component of the network.

In an aspect of the method, the first identifier is an internet protocol (IP) address of the UE for non-access stratum (NAS) messaging.

In an aspect of the method, the first component in the network is a network repository function (NRF).

In an aspect of the method, the second identifier is an internet protocol (IP) address of the NRF for non-access stratum (NAS) messaging.

In an aspect of the method, the second message includes a request for a network function service IP address for NAS messaging.

In an aspect of the method, the third message includes the IP address for NAS messaging of the network function service.

In an aspect of the method, he fourth message is transmitted to the network function identified by the IP address for NAS messaging of the network function service.

In an aspect of the method, the fourth message is an internet protocol 4 (IPv4) protocol message.

In an aspect of the method, the fourth message is an internet protocol 6 (IPv6) protocol message.

In an aspect of the method, the first message is a radio resource control (RRC) setup message.

In an aspect of the present disclosure, a method includes receiving, by a first apparatus, a first message from a user equipment (UE), the first message initiating communication with the first apparatus. The first apparatus transmits a second message to a second apparatus, the second message including a first identifier of the UE. The first apparatus receives a third message from the second apparatus, the third message including a second identifier of the UE and a third identifier that identifies an address of a first component in a network, and transmits a fourth message to the UE, the fourth message including the second identifier of the UE and the third identifier that identifies the address of the first component in the network.

In an aspect of the method, the second identifier is an internet protocol (IP) address of the UE for non-access stratum (NAS) messaging.

In an aspect of the method, the first component in the network is a network repository function (NRF).

In an aspect of the method, the third identifier is an internet protocol (IP) address of the NRF for non-access stratum (NAS) messaging.

In an aspect of the method, the first identifier of the UE is a client identifier for the UE.

In an aspect of the method, the third message is an internet protocol 4 (IPv4) protocol message.

In an aspect of the method, the fourth message is an IPv4 protocol message.

In an aspect of the method, the third message is an internet protocol 6 (IPv6) protocol message.

In an aspect of the method, the fourth message is an IPv6 protocol message.

In an aspect of the method, the first message is a radio resource control (RRC) setup message.

In an aspect of the present disclosure, a method includes receiving, by a first apparatus, a first message from a second apparatus, the first message including a first identifier for a user equipment (UE). The first apparatus assigns a second identifier for the UE, and transmits, to the second apparatus, a second message, the second message including a second identifier of the UE and a third identifier that identifies an address of a first component in a network.

In an aspect of the method, the second identifier is an internet protocol (IP) address of the UE for non-access stratum (NAS) messaging.

In an aspect of the method, the first component in the network is a network repository function (NRF).

In an aspect of the method, the third identifier is an internet protocol (IP) address of the NRF for non-access stratum (NAS) messaging.

In an aspect of the method, the first identifier of the UE is a client identifier for the UE.

In an aspect of the method, the first message is an internet protocol 4 (IPv4) protocol message.

In an aspect of the method, the second message is an IPv4 protocol message.

In an aspect of the method, the first message is an internet protocol 6 (IPv6) protocol message.

In an aspect of the method, the second message is an IPv6 protocol message.

In an aspect of the present disclosure, a user equipment includes at least one processor, and at least one memory storing instructions which, when executed by the at least one processor, cause the user equipment at least to perform at least to perform any of the foregoing methods.

In an aspect of the present disclosure, an apparatus includes at least one processor, and at least one memory storing instructions which, when executed by the at least one processor, cause the user equipment at least to perform at least to perform at least to perform any of the foregoing methods.

In an aspect of the present disclosure, a processor-readable medium storing instructions which, when executed by at least one processor of an apparatus, cause the apparatus at least to perform any of the above methods.

According to some aspects, there is provided the subject matter of the independent claims. Some further aspects are defined in the dependent claims.

### BRIEF DESCRIPTION OF THE DRAWINGS

Some example embodiments will now be described with reference to the accompanying drawings.

FIG. 1 is a diagram of an example embodiment of wireless networking between a network system and a user equipment (UE), according to one illustrated aspect of the disclosure;

FIG. 2 is a diagram of example components of a network system, according to one illustrated aspect of the disclosure;

FIG. 3 is a diagram of an example embodiment of signals and operations among a UE, a gNodeB, a router, and a DHCP server, according to one illustrated aspect of the disclosure; and

FIG. 4 is a representation of an example RRC setup message, according to one illustrated aspect of the disclosure; and

FIG. 5 is a diagram of example embodiment of components of a UE or of a network apparatus, according to one illustrated aspect of the present disclosure.

### DETAILED DESCRIPTION

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures associated with transmitters, receivers, or transceivers have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

Embodiments described in the present disclosure may be implemented in wireless networking apparatuses, such as, without limitation, apparatuses utilizing Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, enhanced LTE (eLTE), 5G New Radio (5G NR), 5G Advance, 6G (and beyond) and 802.11ax (Wi-Fi 6), among other wireless networking systems. The term ‘eLTE’ here denotes the LTE evolution that connects to a 5G core. LTE is also known as evolved UMTS terrestrial radio access (EUTRA) or as evolved UMTS terrestrial radio access network (EUTRAN).

The present disclosure may use the term “serving network device” to refer to a network node or network device (or a portion thereof) that services a UE. As used herein, the terms “transmit to,” “receive from,” and “cooperate with,” (and their variations) include communications that may or may not involve communications through one or more intermediate devices or nodes. The term “acquire” (and its variations) includes acquiring in the first instance or reacquiring after the first instance. The term “connection” may mean a physical connection or a logical connection.

The present disclosure uses 5G NR as an example of a wireless network and may use smartphones and/or extended reality headsets as an example of UEs. It is intended and shall be understood that such examples are merely illustrative, and the present disclosure is applicable to other wireless networks and user equipment.

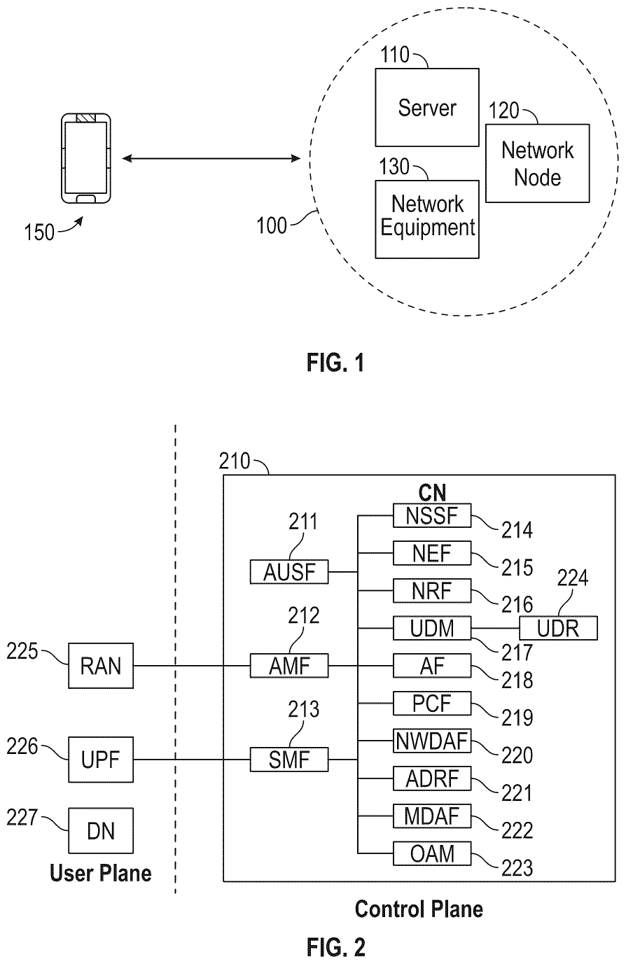

FIG. 1 is a diagram depicting an example of wireless networking between a network system 100 and a user equipment (UE) 150. The network system 100 may include one or more network nodes 120, one or more servers 110, and/or one or more network equipment 130 (e.g., test equipment). The network nodes 120 will be described in more detail below. As used herein, the term “network apparatus” may refer to any component of the network system 100, such as the server 110, the network node 120, the network equipment 130, any component(s) of the foregoing, and/or any other component(s) of the network system 100. Examples of network apparatuses include, without limitation, apparatuses implementing aspects of 5G NR, among others. The present disclosure describes embodiments related to 5G NR and embodiments that involve aspects defined by 3rd Generation Partnership Project (3GPP). However, it is contemplated that embodiments relating to other wireless networking technologies are encompassed within the scope of the present disclosure.

In various embodiments, the server 110 may include an internet engineering taskforce (IETF) dynamic host configuration protocol (DHCP) server. Persons of skill in the art will understand IETF defined protocol mechanisms and techniques for communicating between the DHCP server and other network components. For example, in various embodiments, a router (e.g., site router), not shown, may include the DHCP server. In various embodiments, the DHCP server may reside external to the site router. Persons of skill in the art will understand mechanisms for communication between the site router, DHCP server and additional components in network 100.

The following description provides further details of examples of network nodes. In a 5G NR network, a gNodeB (also known as gNB) may include, e.g., a node that provides NR user plane and control plane protocol terminations towards the UE and that is connected via a NG interface to the 5G core (5GC), e.g., according to 3GPP TS 38.300 V16.6.0 (2021 June) section 3.2, which is hereby incorporated by reference herein.

A gNB supports various protocol layers, e.g., Layer 1 (L1)—physical layer, Layer 2 (L2), and Layer 3 (L3).

The layer 2 (L2) of NR is split into the following sublayers: Medium Access Control (MAC), Radio Link Control (RLC), Packet Data Convergence Protocol (PDCP) and Service Data Adaptation Protocol (SDAP), where, e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC quality of service (QOS) flows;
Control channels include broadcast control channel (BCCH) and physical control channel (PCCH).

Layer 3 (L3) includes, e.g., radio resource control (RRC), e.g., according to 3GPP TS 38.300 V16.6.0 (2021 June) section 6, which is hereby incorporated by reference herein.

A gNB central unit (gNB-CU) includes, e.g., a logical node hosting, e.g., radio resource control (RRC), service data adaptation protocol (SDAP), and packet data convergence protocol (PDCP) protocols of the gNB or RRC and PDCP protocols of the en-gNB, that controls the operation of one or more gNB distributed units (gNB-DUs). The gNB-CU terminates the F1 interface connected with the gNB-DU. A gNB-CU may also be referred to herein as a CU, a central unit, a centralized unit, or a control unit.

A gNB Distributed Unit (gNB-DU) includes, e.g., a logical node hosting, e.g., radio link control (RLC), media access control (MAC), and physical (PHY) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU. A gNB-DU may also be referred to herein as DU or a distributed unit.

As used herein, the term “network node” may refer to any of a gNB, a gNB-CU, or a gNB-DU, or any combination of them. A RAN (radio access network) node or network node such as, e.g., a gNB, gNB-CU, or gNB-DU, or parts thereof, may be implemented using, e.g., an apparatus with at least one processor and/or at least one memory with processor-readable instructions (“program”) configured to support and/or provision and/or process CU and/or DU related functionality and/or features, and/or at least one protocol (sub-) layer of a RAN (radio access network), e.g., layer 2 and/or layer 3. Different functional splits between the central and distributed unit are possible. An example of such an apparatus and components will be described in connection with FIG. 10 below.

The gNB-CU and gNB-DU parts may, e.g., be co-located or physically separated. The gNB-DU may even be split further, e.g., into two parts, e.g., one including processing equipment and one including an antenna. A central unit (CU) may also be called baseband unit/radio equipment controller/cloud-RAN/virtual-RAN (BBU/REC/C-RAN/V-RAN), open-RAN (O-RAN), or part thereof. A distributed unit (DU) may also be called remote radio head/remote radio unit/radio equipment/radio unit (RRH/RRU/RE/RU), or part thereof. Hereinafter, in various example embodiments of the present disclosure, a network node, which supports at least one of central unit functionality or a layer 3 protocol of a radio access network, may be, e.g., a gNB-CU. Similarly, a network node, which supports at least one of distributed unit functionality or a layer 2 protocol of the radio access network, may be, e.g., a gNB-DU.

A gNB-CU may support one or multiple gNB-DUs. A gNB-DU may support one or multiple cells and, thus, could support a serving cell for a user equipment (UE) or support a candidate cell for handover, dual connectivity, and/or carrier aggregation, among other procedures.

The user equipment (UE) 150 may be or include a wireless or mobile device, an apparatus with a radio interface to interact with a RAN (radio access network), a smartphone, an in-vehicle apparatus, an IoT device, or a M2M device, among other types of user equipment. Such UE 150 may include: at least one processor; and at least one memory including program code; where the at least one memory and the computer program code are configured to, with the at least one processor, cause the apparatus at least to perform certain operations, such as, e.g., RRC connection to the RAN. An example of components of a UE will be described in connection with FIG. 5. In embodiments, the UE 150 may be configured to generate a message (e.g., including a cell ID) to be transmitted via radio towards a RAN (e.g., to reach and communicate with a serving cell). In embodiments, the UE 150 may generate and transmit and receive RRC messages containing one or more RRC PDUs (packet data units). Persons skilled in the art will understand RRC protocol as well as other procedures a UE may perform.

With continuing reference to FIG. 1, in the example of a 5G NR network, the network system 100 provides one or more cells, which define a coverage area of the network system 100. As described above, the network system 100 may include a gNB of a 5G NR network or may include any other apparatus configured to control radio communication and manage radio resources within a cell. As used herein, the term “resource” may refer to radio resources, such as a resource block (RB), a physical resource block (PRB), a radio frame, a subframe, a time slot, a sub-band, a frequency region, a sub-carrier, a beam, etc. In embodiments, the network node 120 may be called a base station.

FIG. 1 provides an example and is merely illustrative of a network system 100 and a UE 150. Persons skilled in the art will understand that the network system 100 includes components not illustrated in FIG. 1 and will understand that other user equipment may be in communication with the network system 100.

FIG. 2 is a block diagram of example components of the network system 100 of FIG. 1. A 5G NR network may be described as an example of the network system 100, and it is intended that aspects of the following description shall be applicable to other types of network systems, as well. The network system may operate in accordance with the signals and connections shown in FIG. 1 such that the UE 150 is in communication with the network system 100 through the radio access network 225. Additionally, the network system may be divided into user plane components and functions and control plane components and functions, as shown and described herein. Unless indicated otherwise, the terms “component”, “function”, and “service” may be used interchangeably herein, and they may refer to and be implemented by instructions executed by one or more processors.

Example functions of the components are described below. The example functions are merely illustrative, and it shall be understood that additional operations and functions may be performed by the components described herein. Additionally, the connections between components may be virtual connections over service-based interfaces such that any component may communicate with any other component. In this manner, any component may act as a service “producer,” for any other component that is a service “consumer,” to provide services for network functions.

For example, a core network 210 is described in the control plane of the network system. The core network 210 may include an authentication server function (AUSF) 211, an access and mobility function (AMF) 212, and a session management function (SMF) 213. The core network 210 may also include a network slice selection function (NSSF) 214, a network exposure function (NEF) 215, a network repository function (NRF) 216, and a unified data management function (UDM) 217, which may include a uniform data repository (UDR) 224.

Additional components and functions of the core network 210 may include an application function 218, policy control function (PCF) 219, network data analytics function (NWDAF) 220, analytics data repository function (ADRF) 221, management data analytics function (MDAF) 222, and operations and management function (OAM) 223.

The user plane includes the UE 150, a radio access network (RAN) 225, a user plane function (UPF) 226, and a data network (DN) 227. The RAN 225 may include one or more components described in connection with FIG. 1, such as one or more network nodes. However, the RAN 225 may not be limited to such components. The UPF 226 provides connection for data being transmitted over the RAN 225. The DN 226 identifies services from service providers, Internet access, and third party services, for example.

The AMF 212 processes connection and mobility tasks. The AUSF 211 receives authentication requests from the AMF 212 and interacts with UDM 217 to authenticate and validate network responses for determination of successful authentication. The SMF 213 conducts packet data unit (PDU) session management, as well as manages session context with the UPF 226.

The NSSF 214 may select a network slicing instance (NSI) and determine the allowed network slice selection assistance information (NSSAI). This selection and determination is utilized to set the AMF 212 to provide service to the UE 150. The NEF 215 secures access to network services for third parties to create specialized network services. The NRF 216 acts as a repository to store network functions to allow the functions to register with and discover each other.

The UDM 217 generates authentication vectors for use by the AUSF 211 and ADM 212 and provides user identification handling. The UDM 217 may be connected to the UDR 224 which stores data associated with authentication, applications, or the like. The AF 218 provides application services to a user (e.g., streaming services, etc.). The PCF 219 provides policy control functionality. For example, the PCF 219 may assist in network slicing and mobility management, as well as provide quality of service (QOS) and charging functionality.

The NWDAF 220 collects data (e.g., from the UE 150 and the network system) to perform network analytics and provide insight to functions that utilize the analytics in the providing of services. The ADRF 221 allows the storage, retrieval, and removal of data and analytics by consumers. The MDAF 222 provides additional data analytics services for network functions. The OAM 223 provides provisioning and management processing functions to manage elements in or connected to the network (e.g., UE 150, network nodes, etc.).

FIG. 2 is merely an example of components of a network system, and variations are contemplated to be within the scope of the present disclosure. In embodiments, the network system may include other components not illustrated in FIG. 2. In embodiments, the network system may not include every component illustrated in FIG. 2. In embodiments, the components and connections may be implemented with different connections than those illustrated in FIG. 2. Such and other embodiments are contemplated to be within the scope of the present disclosure.

As described above, in 5G wireless systems, the signaling protocol between a user UE and a core network (NAS-non-access stratum protocol) is carried in RRC signaling on the radio interface, and N2 interface (i.e., next-generation application protocol (NGAP) over stream control transmission protocol (SCTP)) between base station and AMF. For NAS targeting other core network functions, messages are transparently relayed by the AMF over the service based core interfaces. That is, the AMF is a single-point of contact and single-point of failure of reaching any network functions from the UE. Every control plane message from the UE is traversed through the AMF with the NAS protocol.

However, with respect to the concepts of distributed NAS, service-based NAS messaging may be utilized. Accordingly, direct internet protocol (IP) connectivity, for example, may be enabled between the UE and any core network function so that an IP connection (e.g., between the UE and a network function) will carry NAS signaling messages directly. Hence, NAS messaging may not be concentrated and relayed over the AMF, and instead may be signaled directly between the UE and the network function.

In various example embodiments, distributed NAS may use IP protocol, that is, the UE utilizes NAS signaling directly with any core network function using IP. In various examples, the IP packets would carry the NAS message itself. Accordingly, in various example embodiments a service-based NAS implementation (e.g., NAS messages defined as text based HTTP payload) may be utilized.

To achieve the above UE-core network function communication, a wireless system mechanism may be utilized that enables the UE to obtain an IP address for the NAS signaling. The IP address may be obtained before (e.g., during registration request) any NAS signaling commences. Furthermore, a control plane IP address obtained by the UE may be independent from the IP address the UE would use in the user plane for protocol data unit (PDU) sessions (or equivalent sessions) if the UE uses PDU type of IP.

Accordingly, a UE may acquire such an IP address, using a combination and extension of, for example, 3rd generation partnership project (3GPP) defined and/or internet engineering taskforce (IETF) defined protocol mechanisms. For example, the IETF dynamic host configuration protocol (DHCP) mechanism may be utilized in combination with the 3GPP RRC protocol and base station mechanisms to obtain the control plane IP address of a network function. Persons of skill in the art will understand the mechanisms for communicating using the IETF DHCP and 3GPP RRC protocols.

The terms “service” and “network function” may be used interchangeably herein, such that a description referring to one of the terms shall be treated as though the description also referred to the other term.

As used herein, a communication with a radio access network (RAN) may refer to and mean a communication with a portion of a RAN, such as with a network node (e.g., a DU and/or a CU), or another portion of a RAN. As used herein, a communication with a core network may refer to and mean a communication with one or more services/network functions of the core network, such as AMF or another service of a core network.

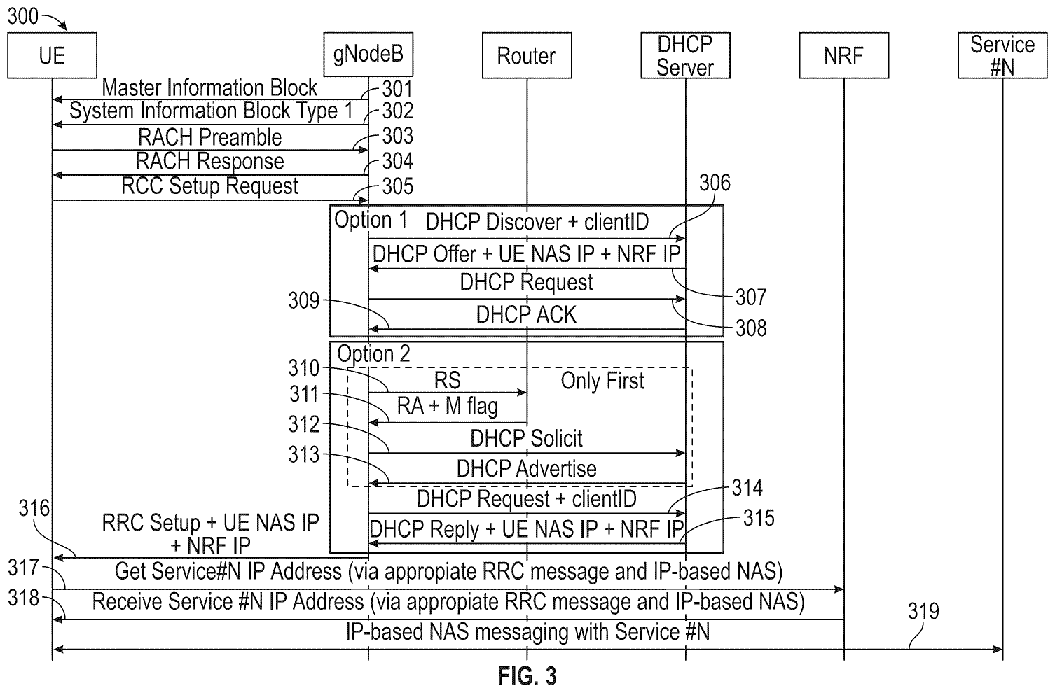

FIG. 3 is a diagram of an example embodiment of signals and operations among a UE, a gNodeB, a router, and a DHCP server, according to one illustrated aspect of the disclosure. The following paragraphs will describe various signals and operations. It will be understood that a described signal may have associated operations and a described operation may have associated signals.

In various embodiments, the DHCP server may reside in a site router (e.g., router) connecting multiple network nodes (e.g., base stations) to the Internet protocol (IP) domain network. In various embodiments, the site router may reside external to the DHCP server and connect to the DHCP server. Persons of skill in the art will understand the various connection schemes for providing the DHCP server connection to one or more network nodes.

At operation 301, the gNodeB transmits a master information block (MIB) message to the UE and the UE receives the master information block message. The master information block message, in some embodiments, may carries information about the radio bearer, physical channel, and transport channel of the 5G new radio (NR) network. In some example embodiments, the MIB may convey information such as carrier frequency, bandwidth, modulation, coding rate, and access control parameters of 5G NR.

At operation 302, the gNodeB transmits a system information block type 1 to the UE and the UE receives the system information block type 1. In some example embodiments, the system information block type 1 may include cell access related information (e.g., a public land mobile network (PLMN) identity list, tracking area code, cell identity, etc.), information for cell selection (e.g., minimum required receive (Rx) level in the cell and offset), p-Max, frequency band indicator, and scheduling information. Persons of skill in the art will understand information to be sent in the master information block message and the system information block type 1 message.

Upon receiving the master information block message and the system information block type 1 message, at operation 303, the UE transmits a random access channel (RACH) preamble message to the gNodeB and the gNodeB receives the RACH preamble message. In response to the receiving the RACH preamble message, at operation 304, the gNodeB transmits a RACH response message to the UE and the UE receives the RACH response message. At operation 305, the UE transmits an RRC setup request message to the gNodeB and the gNodeB receives the RRC setup request message. Persons of skill in the art will appreciate and understand the RACH preamble message, RACH response message and RACH setup request message, as well as the information that may be contained in the messages.

Upon receiving the RRC setup request message, the gNodeB may perform one of two options.

In some example embodiments, the gNodeB may perform a first option (option 1) procedure, which in various example embodiments, may be a procedure utilizing IPv4 protocols. Accordingly, at operation 306, the gNodeB transmits a DHCP discover message that includes the client identifier (clientID) of the UE from which the gNodeB received the RRC setup request message to the DHCP server (e.g., via the router) and the DHCP server receives the DHCP discover message that includes the clientID of the UE. The client identifier may be specified in RFC 2131. There are several ways to assign a unique ID for the UE based on unique UE IDs (e.g., RAN UE NGAP ID, S-TMSI, etc.).

In response to receiving the DHCP discover message that includes the clientID of the UE, at operation 307, the DHCP server transmits a DHCP offer message to the gNodeB and the gNodeB receives the DHCP offer message. The DHCP offer message, in various embodiments, may include an NAS IP address for the UE (UE NAS IP) and the IP address of the NRF (NRF IP). In one embodiment, the NRF IP address may be contained in the DHCP offer message as part of an “options” field of the DHCP message, which may be defined as a new option type, or a vendor specific custom option type with a currently unassigned option code. In various example embodiments, an option with an existing option code may be used to carry the NRF IP address. The UE NAS IP may be assigned by the DHCP server and may be unique to the UE associated with the clientID.

Upon acceptance of the UE NAS IP address, at operation 308, the gNodeB transmits a DHCP request message to the DHCP server and the DHCP server receives the DHCP request message. The DHCP server completes the process in option 1 by transmitting, at operation 309, a DHCP acknowledgement message to the gNodeB and the gNodeB receives the DHCP acknowledgment message.

Option 1 may be performed only the first time the gNodeB receives the RRC setup request message from the UE or may be performed periodically by the gNodeB to acquire the UE NAS IP address. In various embodiments, once the gNodeB acquires the IP address for the UE, the gNodeB may renew the IP address through transmitting a DHCP request only.

In various embodiments, upon receiving the RRC setup request by the gNodeB, the gNodeB may perform a second option (option 2). In some example embodiments, option 2 may be a procedure utilizing IPv6 protocols. For example, at operation 310, the gNodeB transmits a router solicitation (RS) message to the router and the router receives the RS message. The RS message discovers the available router that includes information indicating whether the present network domain is automatically managed for assigning and managing IP addresses to facilitate IP communication between the UE and a network function.

At operation 311, the router transmits a router advertisement (RA) message to the gNodeB and the gNodeB receives the RA message that indicates the DHCP protocol the gNodeB is to use. For example, the RA message may include an M flag which indicates the gNodeB is to use, for example, the stateful DHCPv6 process.

After (e.g., upon) receipt of the RA message, the gNodeB may commence looking for available DHCP servers. Accordingly, at operation 312, the gNodeB transmits a DHCP solicit message to the DHCP server and the DHCP server receives the DHCP solicit message. At operation 313, the available DHCP server transmits a DHCP advertise message to the gNodeB and the gNodeB receives the DHCP advertise message. In various example embodiments, the gNodeB may transmit multiple DHCP solicit messages to multiple potential DHCP servers. After (e.g., upon) discovering available DHCP servers, the gNodeB may transmit subsequent DHCP request to a selected available DHCP server.

In some example embodiments, operations 310-313 may be performed only a first time the gNodeB receives an RRC setup request message from any UE from which it first receives the RRC setup request message. In various example embodiments, the gNodeB may then aware of the DHCP server for subsequent RRC setup request messages that are received.

At operation 314, the gNodeB transmits a DHCP request message to the DHCP server and the DHCP server receives the DHCP request message. The DHCP request message includes the clientID of the UE, which may be a DHCP unique identifier (DUID) in IETF terminology described in RFC8415. The DHCP server completes the process in option 2 by transmitting, at operation 315, a DHCP reply message to the gNodeB and the gNodeB receives the DHCP acknowledgment message. The DHCP reply message, in various example embodiments, may include an NAS IP address for the UE (UE NAS IP) and the IP address of the NRF (NRF IP). In various embodiments, the NRF IP address may be contained in the DHCP offer message as part of an “options” field of DHCP message, which may be defined as a new option type, or a vendor specific custom option type with a currently unassigned option code. In other various embodiments, an option with an existing option code may be used to carry NRF IP address. The UE NAS IP may be assigned by the DHCP server and may be unique to the UE associated with the clientID.

Once the gNodeB possesses the UE NAS IP and the NRF IP, the gNodeB may communicate the information to the UE. Therefore, at operation 316, the gNodeB transmits an RRC setup message to the UE and the UE receives the RRC setup message. The RRC setup message may include the UE NAS IP and the NRF IP.

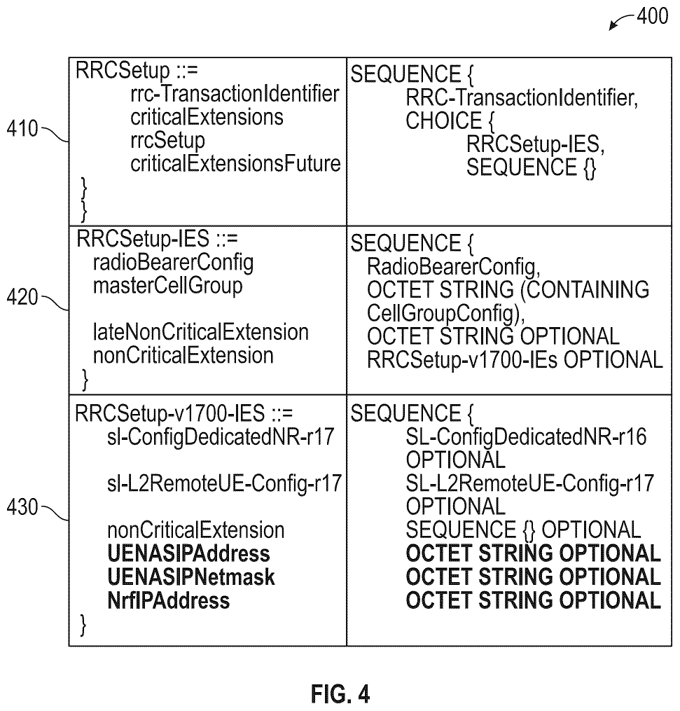

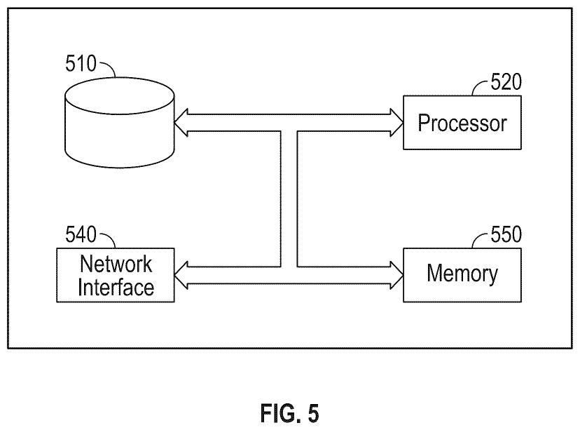

FIG. 4. is a representation of an example RRC setup message 400, according to one illustrated aspect of the disclosure. As shown in FIG. 4, the RRC setup message includes a header 410, and information elements (IE) 420 and 430. Although persons of skill in the art may understand various information elements provided in the RRC setup message, the RRC setup message also include a UENASIPAddress IE, a UENASIPNetmask IE, and an NrfIP Address IE. In various embodiments, the UENASIPAddress IE may include information related to the IP address of the UE to be used in NAS messaging/signaling. In various embodiments, the UENASIPNetmask IE may include the IP network mask for the UE NAS IP address. In various embodiments, the NrfIP Address IE may include the IP address of the NRF (or an equivalent core network functionality).

Referring once again to FIG. 3, after (e.g., upon) receipt of the RRC setup message, the UE may acquire IP service addresses from the NRF (or other equivalent core network functionality) in order to perform NAS messaging. In various example embodiments, at operation 317, the UE transmits a get service #N IP address message (e.g., via an appropriate RRC message and IP-based NAS message) to the NRF and the NRF receives the get service #N IP address message. In various embodiments, the get service #N IP address message may include a request for a first NAS service IP address for a network function for which the UE desires a service. The request for NAS service IP address may be requested by the UE directly to the NRF via IP messaging. In various example embodiments, an appropriate RRC message at operation 317 may include an RRC setup complete message.

At operation 318, the NRF transmits a receive service #N IP address message (e.g., via an appropriate RRC message and IP-based NAS message) to the UE and the UE receives the receive service #N IP address message. The receive service #N IP address message, in various embodiments, includes the IP address of the network function requested by the UE.

Accordingly, at operation 319, IP-based NAS messaging may commence between the UE and the network function (service #N) directly (e.g., via gNodeB). Operations 316-319 may be performed any number of times for the UE to perform service IP address discovery and NAS messaging for additional network functions #N.

Accordingly, FIG. 3 describes signals and operations involving, for example, a UE, a gNodeB and a DHCP server. The following will describe operations from the perspective each of the UE, gNodeB and DHCP server.

The following describes operations from the perspective of the UE. From such a perspective, a method may include receiving a first message from a gNodeB (e.g., at operation 316 above), the first message including a first identifier of the UE and a second identifier that identifies an address of a first component in a network. The UE transmits a second message (e.g., at operation 317 above) to the gNodeB, the second message including a request for an address of a second component of the network. The UE receives a third message (e.g., at operation 318 above) from the gNodeB, the third message including a third identifier of the address of the second component of the network, and the UE transmits a fourth message (e.g., at operation 319 above) to the second component of the network, the fourth message including the identifier of the address of the second component of the network.

The following describes operations from the perspective of the gNodeB. From such a perspective, a method may include receiving, by the gNodeB, a first message (e.g., at operation 305 above) from a UE, the first message initiating communication with the gNodeB. The gNodeB transmits a second message (e.g., at operation 306 or operation 314) to a DHCP server, the second message including a first identifier of the UE. The gNodeB receives a third message (e.g., at operation 307 or operation 315) from the DHCP server, the third message including a second identifier of the UE and a third identifier that identifies an address of a first component in a network, and transmits a fourth message (e.g., at operation 316) to the UE, the fourth message including the second identifier of the UE and the third identifier that identifies the address of the first component in the network.

The following describes operations from the perspective of the DHCP. From such a perspective, a method may include the DHCP server receiving a first message (e.g., at operation at operation 306 or operation 314) from a gNodeB, the first message including a first identifier for a UE. The DHCP server assigns a second identifier for the UE, and transmits, to the gNodeB, a second message (e.g., at operation 307 or operation 315), the second message including a second identifier of the UE and a third identifier that identifies an address of a first component in a network.

Referring now to FIG. 5, there is shown a block diagram of example components of a UE or a network apparatus (e.g., of a RAN or a core network). The apparatus includes an electronic storage 510, a processor 520, a network interface 540, and a memory 550. The various components may be communicatively coupled with each other. The processor 520 may be and may include any type of processor, such as a single-core central processing unit (CPU), a multi-core CPU, a microprocessor, a digital signal processor (DSP), a System-on-Chip (SoC), or any other type of processor. The memory 550 may be a volatile type of memory, e.g., RAM, or a non-volatile type of memory, e.g., NAND flash memory. The memory 550 includes processor-readable instructions that are executable by the processor 520 to cause the apparatus to perform various operations, including those mentioned herein, such as the operations of FIGS. 3-4.

The electronic storage 510 may be and include any type of electronic storage used for storing data, such as hard disk drive, solid state drive, optical disc, and/or other non-transitory computer-readable mediums, among other types of electronic storage. The electronic storage 510 stores processor-readable instructions for causing or configured for causing the apparatus to perform its operations and also stores data associated with such operations, such as storing data relating to 5G NR standards, among other data. The network interface 540 may implement wireless networking technologies such as 5G NR and/or other wireless networking technologies. For example, in various example embodiments, the network interface may include a transceiver and antenna/antennas.

The components shown in FIG. 5 are merely examples, and persons skilled in the art will understand that an apparatus includes other components not illustrated and may include multiples of any of the illustrated components. For example, in various example embodiments, the UE may include a user interface, such as a display and/or keyboard communicatively coupled with the other components of the UE. Such and other embodiments are contemplated to be within the scope of the present disclosure.

Further embodiments of the present disclosure include the following examples.

Example 1.1. An apparatus, comprising:
means for receiving, by a user equipment (UE), a first message from an apparatus, the first message including a first identifier of the UE and a second identifier that identifies an address of a first component in a network;
means for transmitting, by the UE, a second message to the apparatus, the second message including a request for an address of a second component of the network;
means for receiving, by the UE, a third message from the network apparatus, the third message including a third identifier of the address of the second component of the network; and
means for transmitting, by the UE, a fourth message to the second component of the network, the fourth message including the identifier of the address of the second component of the network.

Example 1.2. The apparatus of example 1.1, wherein the first identifier is an internet protocol (IP) address of the UE for non-access stratum (NAS) messaging.

Example 1.3. The apparatus of example 1.2, wherein the first component in the network is a network repository function (NRF).

Example 1.4. The apparatus of example 1.3, wherein the second identifier is an internet protocol (IP) address of the NRF for non-access stratum (NAS) messaging.

Example 1.5. The apparatus as in any of examples 1.1-1.4, wherein the second message includes a request for a network function service IP address for NAS messaging.

Example 1.6. The apparatus of example 1.5, wherein the third message includes the IP address for NAS messaging of the network function service.

Example 1.7. The apparatus of example 1.6, wherein the fourth message is transmitted to the network function identified by the IP address for NAS messaging of the network function service.

Example 1.8. The apparatus of example 1.1, wherein the fourth message is an internet protocol 4 (IPv4) protocol message.

Example 1.9. The apparatus of example 1.1, wherein the fourth message is an internet protocol 6 (IPv6) protocol message.

Example 1.10. The apparatus of example 1.1, wherein the first message is a radio resource control (RRC) setup message.

Example 2.1. An apparatus, comprising:
means for receiving, by the apparatus, a first message from a user equipment (UE), the first message initiating communication with the first apparatus;
means for transmitting, by the apparatus, a second message to a second apparatus, the second message including a first identifier of the UE;
means for receiving, by the apparatus, a third message from the second apparatus, the third message including a second identifier of the UE and a third identifier that identifies an address of a first component in a network; and
means for transmitting, by the apparatus to the UE, a fourth message, the fourth message including the second identifier of the UE and the third identifier that identifies the address of the first component in the network.

Example 2.2. The apparatus of example 2.1, wherein the second identifier is an internet protocol (IP) address of the UE for non-access stratum (NAS) messaging.

Example 2.3. The apparatus of example 2.2, wherein the first component in the network is a network repository function (NRF).

Example 2.4. The apparatus of example 2.3, wherein the third identifier is an internet protocol (IP) address of the NRF for non-access stratum (NAS) messaging.

Example 2.5. The apparatus of example 2.1, wherein the first identifier of the UE is a client identifier for the UE.

Example 2.6. The apparatus of example 2.1, wherein the third message is an internet protocol 4 (IPv4) protocol message.

Example 2.7. The apparatus of example 2.6, wherein the fourth message is an IPv4 protocol message.

Example 2.8. The apparatus of example 2.1, wherein the third message is an internet protocol 6 (IPv6) protocol message.

Example 2.9. The apparatus of example 2.8, wherein the fourth message is an IPv6 protocol message.

Example 2.10. The apparatus of example 2.1, wherein the first message is a radio resource control (RRC) setup message.

Example 3.1. An apparatus, comprising:
means for receiving, by the apparatus, a first message from a second apparatus, the first message including a first identifier for a user equipment (UE);
means for assigning, by the apparatus, a second identifier for the UE; and
means for transmitting, by the apparatus, to the second apparatus, a second message, the second message including a second identifier of the UE and a third identifier that identifies an address of a first component in a network.

Example 3.2. The apparatus of example 3.1, wherein the second identifier is an internet protocol (IP) address of the UE for non-access stratum (NAS) messaging.

Example 3.3. The apparatus of example 3.2, wherein the first component in the network is a network repository function (NRF).

Example 3.4. The apparatus of example 3.3, wherein the third identifier is an internet protocol (IP) address of the NRF for non-access stratum (NAS) messaging.

Example 3.5. The apparatus of example 3.1, wherein the first identifier of the UE is a client identifier for the UE.

Example 3.6. The apparatus of example 3.1, wherein the first message is an internet protocol 4 (IPv4) protocol message.

Example 3.7. The apparatus of example 3.6, wherein the second message is an IPv4 protocol message.

Example 3.8. The apparatus of example 3.1, wherein the first message is an internet protocol 6 (IPv6) protocol message.

Example 3.9. The apparatus of example 3.8, wherein the second message is an IPv6 protocol message.

The embodiments and aspects disclosed herein are examples of the present disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

For example, the RRC setup message sent by the base station depicts information elements for providing UE IP address and NRF IP address information. However, this information may be provided in other fields of the RRC Setup message.

Additionally, the means for performing functions and methods described herein may be associated with components as described in FIG. 5, and in various example embodiments may include hardware, software, circuitry, or otherwise, of those components.

The phrases “in an aspect,” “in aspects,” “in various aspects,” “in some aspects,” or “in other aspects” may each refer to one or more of the same or different aspects in accordance with this present disclosure. The phrase “a plurality of” may refer to two or more.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

While aspects of the present disclosure have been shown in the drawings, it is not intended that the present disclosure be limited thereto, as it is intended that the present disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

What is claimed is:

1. A method of a user equipment (UE), the method comprising:
receiving a radio resource control (RRC) setup message from a radio access network (RAN) node, the RRC message including:
an internet protocol (IP) address of the UE for non-access stratum (NAS) messaging, and
an IP address of a network repository function (NRF) in a network for NAS messaging;
transmitting a get service message to the NRF, the get service message including a request for a NAS service IP address of a network function for which the UE desires a service;
receiving a receive service message from the NRF, the receive service message including the NAS service IP address of the network function; and
transmitting an IP-based NAS message to the network function to obtain the service, the IP-based NAS message including the NAS service IP address of the network function.

2. The method of claim 1, wherein the get service message is transmitted to the NRF via an RRC message and an IP-based NAS message.

3. The method of claim 1, wherein the get service message include an RRC setup complete message.

4. The method of claim 1, wherein the receive service message is received from the NRF via an RRC message and an IP-based NAS message.

5. The method of claim 1, wherein the IP-based NAS message is an internet protocol 4 (IPv4) protocol message.

6. The method of claim 1, wherein the IP-based NAS message is an internet protocol 6 (IPv6) protocol message.

7. The method of claim 1, wherein the radio access network (RAN) node comprises a gNodeB.

8. A user equipment (UE), comprising:
at least one processor; and
at least one memory storing instructions which, when executed by the at least one processor, cause the user equipment at least to perform:
receiving a radio resource control (RRC) setup message from a radio access network (RAN) node, the RRC message including:
an internet protocol (IP) address of the UE for non-access stratum (NAS) messaging, and
an IP address of a network repository function (NRF) in a network for non-access stratum (NAS) messaging;
transmitting a get service message to the NRF, the get service message including a request for a NAS service IP address of a network function for which the UE desires a service;
receiving a receive service message from the NRF, the receive service message including the NAS service IP address of the network function; and
transmitting an IP-based NAS message to the network function to obtain the service, the IP-based NAS message including the NAS service IP address of the network function.

9. The UE of claim 8, wherein the get service message is transmitted to the NRF via an RRC message and an IP-based NAS message.

10. The UE of claim 9, wherein the get service message include an RRC setup complete message.

11. The UE of claim 9, wherein the receive service message is received from the NRF via an RRC message and an IP-based NAS message.

12. The UE of claim 9, wherein the IP-based NAS message is an internet protocol 4 (IPv4) protocol message.

13. The UE of claim 9, wherein the IP-based NAS message is an internet protocol 6 (IPv6) protocol message.

14. The UE of claim 1, wherein the radio access network (RAN) node comprises a gNodeB.

15. A communication system comprising:
a user equipment;
a radio access network (RAN) node; and
a dynamic host configuration protocol (DHCP) server
wherein user equipment (UE) comprises at least one processor and at least one memory storing instructions which, when executed by the at least one processor, cause the user equipment at least to perform:
receiving a radio resource control (RRC) setup message from the RAN node, the RRC message including:
an internet protocol (IP) address of the UE for non-access stratum (NAS) messaging, and
an IP address of a network repository function (NRF) in a network for non-access stratum (NAS) messaging;
transmitting a get service message to the NRF, the get service message including a request for a NAS service IP address of a network function for which the UE desires a service;
receiving a receive service message from the NRF, the receive service message including the NAS service IP address of the network function; and
transmitting an IP-based NAS message to the network function to obtain the service, the IP-based NAS message including the NAS service IP address of the network function; and
wherein the RAN node comprises at least one processor and at least one memory storing instructions which, when executed by the at least one processor, cause the RAN node at least to perform:
receiving, a RRC setup request message from the UE, the RRC setup request message initiating communication with the RAN node;
transmitting a first message to the DCHP server, the first message including a client identifier for the UE;
receiving a second message from the DHCP server, the third message including the IP address of the UE for NAS messaging and the IP address of the NRF for NAS messaging in the network; and
transmitting, to the UE, the RRC setup message; and
wherein the DHCP server comprises at least one processor and at least one memory storing instructions which, when executed by the at least one processor, cause the DHCP server at least to perform:
receiving the first message from the RAN node;
assigning for the UE, the IP address of the UE for NAS messaging; and
transmitting to the RAN node, the second message, the second message including the IP address of the UE for NAS messaging and the IP address of the NRF for NAS messaging in the network.

16. The method of claim 15, wherein the first message comprises a DHCP offer message that is an internet protocol 4 (IPv4) protocol message.

17. The method of claim 16, wherein the second message comprises a DHCP discover message that is an IPv4 protocol message and.

18. The method of claim 15, wherein the first message comprises a DHCP reply message that is an internet protocol 6 (IPv6) protocol message.

19. The method of claim 18, wherein the second message comprises a DHCP request message that is an IPv6 protocol message.
